(19) United States
(12) Patent Application Publication
(10) Pub. No.: US 2018/0025497 A1
(43) Pub. Date: Jan. 25, 2018

(54) SPEED DETECTING METHOD AND SPEED DETECTING APPARATUS

(71) Applicant: PixArt Imaging Inc., Hsin-Chu City (TW)

(72) Inventor: Hung-Ching Lai, Hsin-Chu City (TW)

(21) Appl. No.: 15/387,660

(22) Filed: Dec. 22, 2016

(30) Foreign Application Priority Data
Jul. 25, 2016 (TW) 105123366

(51) Int. Cl. G06T 7/246; H04N 5/225

(52) U.S. Cl. CPC G06T 7/246; H04N 5/2256; G06T 2207/30248

(57) ABSTRACT

A speed detecting apparatus comprising: an image capturing apparatus, configured to capture at least one object to be detected image for an object to be detected; and a speed computing apparatus, configured to compute a moving speed for the object to be detected according to an after image length for an after image in the object to be detected image.

### BACKGROUND OF THE INVENTION

### 1. Field of the Invention

The present invention relates to a speed detecting method and a speed detecting apparatus, and particularly relates to a speed detecting method and a speed detecting apparatus which can detects a speed via images.

### 2. Description of the Prior Art

A conventional speed detecting apparatus always applies a radar speed detecting method or a laser speed detecting method to detect a relative speed between an object to be detected and a speed detecting apparatus.

The radar speed detecting method applies the Doppler Effect for sonic waves. A reflection frequency for sonic waves is higher than an emission frequency of sonic waves while the object to be detected is approaching the speed detecting apparatus. On the opposite, a reflection frequency for sonic waves is lower than an emission frequency of sonic waves while the object to be detected is leaving the speed detecting apparatus. A relative speed between the object to be detected and the speed detecting apparatus can be acquired via detecting variations for reflection frequencies of sonic waves. The laser speed detecting method means projecting light to the object to be detected, and computes the relative speed between the object to be detected and the speed detecting apparatus according to transmission time of the reflected light.

However, the above-mentioned two speed detecting methods have some disadvantages. The disadvantage for the radar speed detecting method is: an emission direction for sonic waves of the speed detecting apparatus should face a direction that the object to be detected approaches, or the detected speed is not accurate. Also, the disadvantage for the laser speed detecting method is: such method cannot be applied while the speed detecting apparatus is in a moving state, thus the peed detecting apparatus must be located to a fixed position. Besides, either a radar speed detecting apparatus or a laser speed detecting apparatus is expensive.

### SUMMARY OF THE INVENTION

Therefore, one objective of the present invention is to provide a speed detecting method and a speed detecting apparatus which can detect a moving speed according to images.

Another objective of the present invention is to provide a speed detecting method and a speed detecting apparatus which can detect an object to be detected distance, to increase the accuracy for the moving speed detecting.

One embodiment of the present invention discloses a speed detecting apparatus, which comprises: an image capturing apparatus, configured to capture at least one object to be detected image for an object to be detected; and a speed computing apparatus, configured to compute a moving speed for the object to be detected according to an after image length for an after image in the object to be detected image.

Another embodiment of the present invention discloses a speed detecting apparatus, which comprises: a distance computing apparatus, configured to compute an object to be detected distance between the speed detecting apparatus and an objected to be detected; and a speed computing apparatus, configured to compute a moving speed of the object to be detected according to the object to be detected distance.

Other embodiments for the present invention disclose speed detecting methods corresponding to above-mentioned embodiments. Details for these speed detecting methods can be acquired in view of above-mentioned embodiments, thus are omitted for brevity here.

In view of above-mentioned embodiments, an image can be applied to detect the moving speed of an object to be detected, thus the disadvantages in prior art can be improved. Also, the distance between the object to be detected and the image capturing apparatus can be further computed as a basement for detecting a moving speed. By this way, the accuracy for detecting a moving speed can be increased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating how to use a mobile phone to detect a moving speed of an object to be detected according to one embodiment of the present invention.

FIG. 2 is a schematic diagram illustrating how to use a mobile phone to detect a moving speed of an object to be detected according to another embodiment of the present invention.

FIG. 3 illustrates object to be detected images according to one embodiment of the present invention.

FIG. 4 illustrates object to be detected images according to another embodiment of the present invention.

FIG. 5 is a schematic diagram illustrating steps for computing a moving speed for the object to be detected according to one embodiment of the present invention.

FIG. 6 is a schematic diagram illustrating a speed detecting apparatus according to one embodiment of the present invention.

### DETAILED DESCRIPTION

In following descriptions, several embodiments are provided to explain concept of the present invention. It will be appreciated the devices, apparatus, and modules illustrated in following embodiments can be implemented by hardware such as a circuit, or by hardware and software (ex. writing a program to a processor).

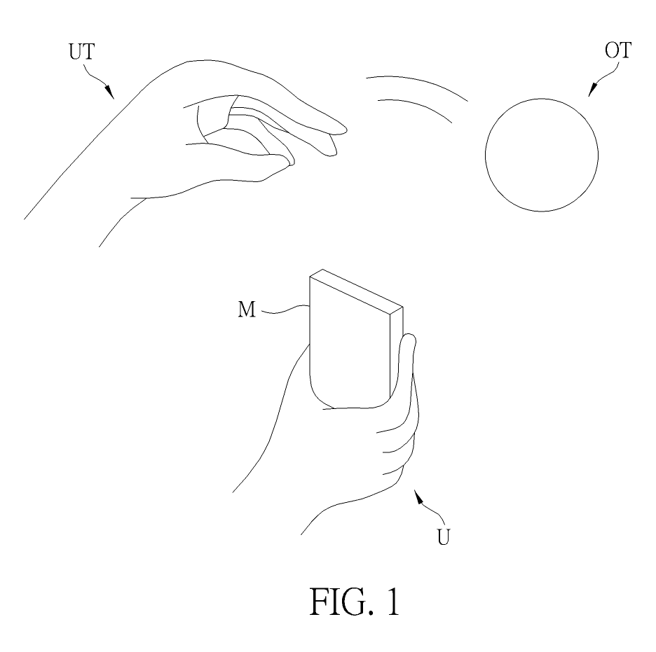

FIG. 1 is a schematic diagram illustrating how to use a mobile phone to detect a moving speed of an object to be detected according to one embodiment of the present invention. As illustrated in FIG. 1, while the user to be tested UT throwing an object to be detected OT (a ball in this example), the user U uses a mobile phone M (can be replace by other electronic apparatuses) with an image capturing apparatus such as a camera to photograph the object to be detected OT, to acquire at least one object to be detected image of the object to be detected OT. After that, a speed computing apparatus in the mobile phone M computes a moving speed for the object to be detected according to an after image length for an after image in the object to be detected image.

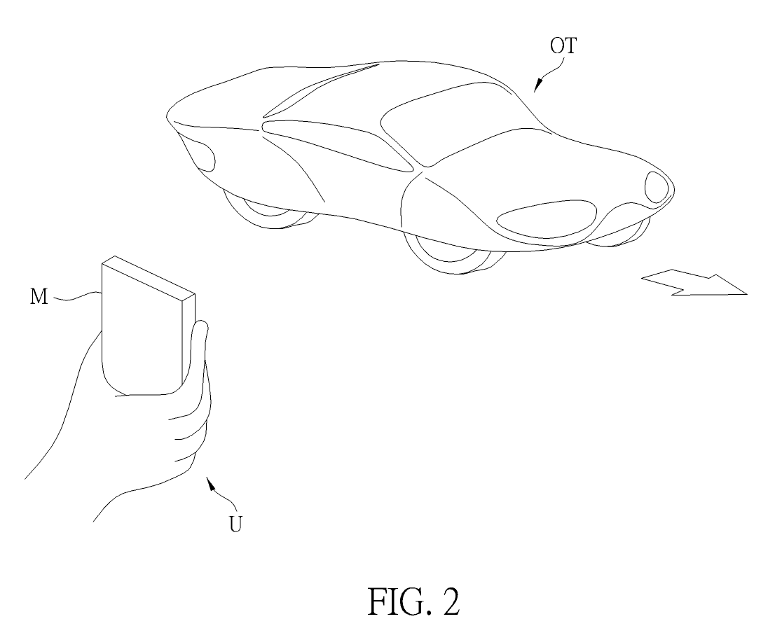

In following descriptions, the method for computing a moving speed for the object to be detected according to an after image length is detailedly explained. Please note, in following embodiments, a ball is taken as an example for the object to be detected OT. However, the object to be detected OT is not limited to a ball or a similar object having a small size and can be other kinds of objects. For example, in the embodiment of FIG. 2, the object to be detected OT is a car. Even if the object to be detected OT is a car, the user U can still use the image capturing apparatus of the mobile phone M to photograph the object to be detected OT, to acquire at least one object to be detected image of the object to be detected OT. Also, the user can still use a speed computing apparatus in the mobile phone M to compute a moving speed for the object to be detected according to the after image length.

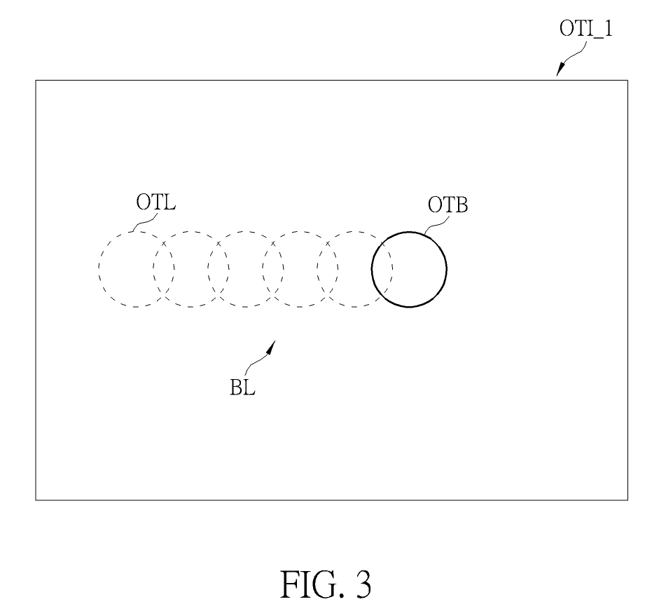

FIG. 3 illustrates object to be detected images according to one embodiment of the present invention. As illustrated in FIG. 3, the object to be detected image OTI_1 comprises an after image BL while the object to be detected moving. The distance between terminals OTL and OTB of the after image BL is the above-mentioned after image length. The after image length is directly proportional to the moving speed of the object to be detected image OT and directly proportional to an image capturing time interval. The image capturing time interval means a necessary time interval for capturing an image. Also, the image capturing time interval can be decided by various kinds of parameters, for example, a shutter time for the image capturing apparatus or a frame rate for the image sensor in the image capturing apparatus.

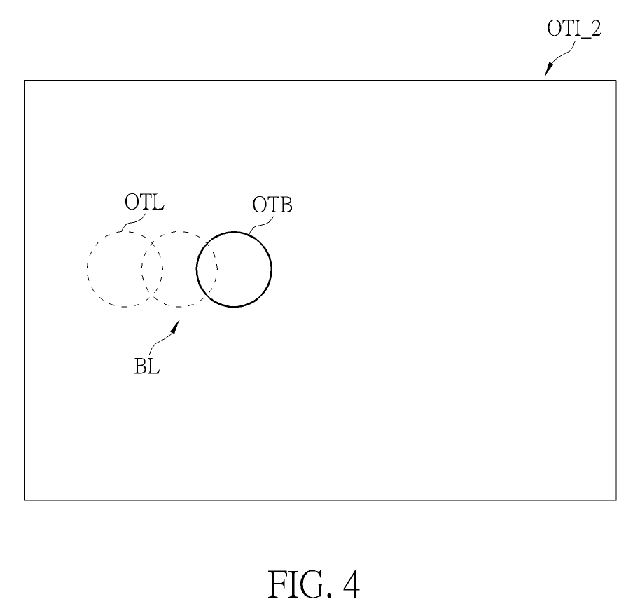

The after image length is longer if the image capturing time interval keeps the same but the moving speed of the object to be detected OT is faster. In one embodiment, the object to be tested image OTI_1 in FIG. 3 and the object to be tested image OTI_2 in FIG. 4 are captured via the same image capturing time intervals. However, the after image length for the object to be tested image OTI_1 in FIG. 3 is longer than the after image length for the object to be tested image OTI_2 in FIG. 4. Therefore, it can be determined that a moving speed for the object to be detected OT in FIG. 3 is faster than which for the object to be detected OT in FIG. 4. The method for computing a real moving speed will be explained in other embodiments.

Besides an after image length of the object to be detected image, the moving speed can be further determined according to an object to be detected distance between the object to be detected and the speed detecting apparatus. In one embodiment, the above-mentioned mobile phone M further comprises a distance computing apparatus configured to compute an object to be detected distance between the object to be detected and the speed detecting apparatus. Various kinds of apparatuses can be applied to implement such distance computing apparatus. For example, the distance computing apparatus can be a distance computing apparatus using laser. Besides, the distance computing apparatus can be a depth sensor which can be applied to acquire image depth information such as a depth map for the images captured by the image capturing apparatus. Based on such image depth information, an object to be detected distance between the speed detecting apparatus and the object to be detected can be acquired, which is substantially equal to a distance between the image capturing apparatus and the object to be detected. In one embodiment, the mobile phone can further comprise a light emitting device such as an LED to illuminate the object to be detected before the object to be detected distance is computed. By this way, a clearer object to be detected image can be acquired and thereby the computing for the object to be detected distance can be more accurate.

Additionally, the object to be detected distance is not limited to be generated by a distance computing apparatus. In one embodiment, the object to be detected distance is set according to a distance setting signal, which can be input by a user. Besides directly setting the object to be detected distance according to a distance setting signal, in one embodiment a distance range is set according the distance setting signal. If the object to be detected distance computed by the distance computing apparatus is larger than such distance range, the object to be detected distance is determined to be invalid. By this way, the computing for the object to be detected distance can be more accurate.

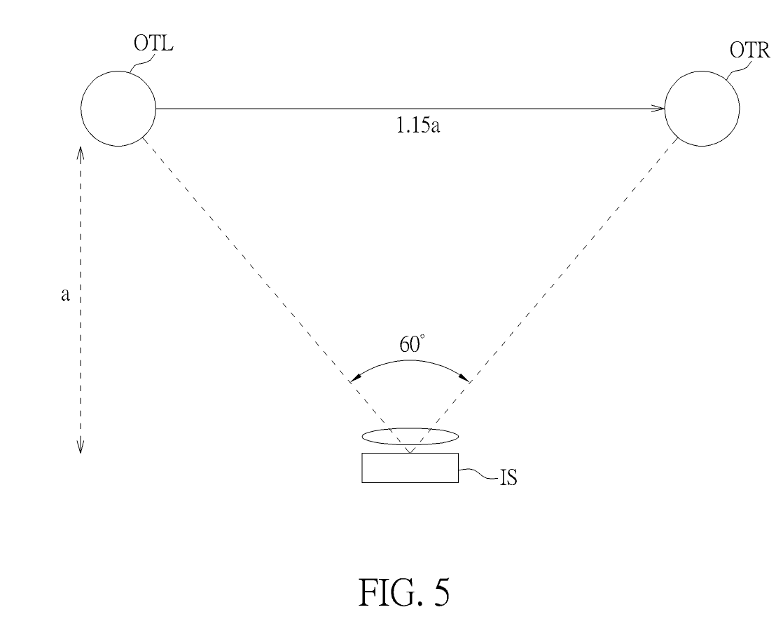

FIG. 5 is a schematic diagram illustrating steps for computing a moving speed for the object to be detected according to one embodiment of the present invention. As illustrated in FIG. 5, the image sensor IS in the image capturing apparatus captures an object to be detected image. Also, the two image terminals OTL and OTR of the object to be detected image form an angle with 60 degrees to the image sensor. Additionally, the object to be detected distance is a, thus the after image length in the object to be detected image corresponds to a real distance 1.15 a. Accordingly, if a equals 1 m, the after image length in the object to be detected image corresponds to a real distance 1.15 m. Also, if the frame rate is 37 frames per second, which means the time interval for capturing an image is 0.027 second. Therefore, it can be acquired that the moving speed of the object to be detected is 41.67 m/sec, which means 150 km/hr.

In above-mentioned embodiments, since the moving distance of the object to be detected is acquired based on the after image length, acquiring an accurate distance between the object to be detected and the image sensor is important. For example, if the moving speeds for the object to be detected are the same but the object to be detected distances are different, the object to be detected having a larger object to be detected distance generates an after image length smaller than an after image length generated by the object to be detected having a smaller object to be detected distance.

In view of above-mentioned contents, if a more accurate moving distance or moving speed is needed, it's better to acquire a distance range for the object to be detected. However, if only a relative moving speed is desired, the object to be detected distance between the object to be detected and the image sensor are not necessary.

Please note, in above-mentioned embodiments, only one object to be detected image is applied for explaining. However, in one embodiment, the moving speed of the object to be detected is acquired based on after image lengths for a plurality of object to be detected images. For example, three object to be detected images are captured, and after image lengths for these object to be detected images are averaged, and then the moving speed for the object to be detected is accordingly acquired. By this way, the accuracy for computing the moving speed of the object to be detected is increased.

In view of above-mentioned embodiments, a speed detecting method applied to a speed detecting apparatus comprising an image capturing apparatus can be acquired. The speed detecting method comprises: a) capturing at least one object to be detected image (ex. OTI_1 in FIG. 3) for an object to be detected via the image capturing apparatus; and (b) computing a moving speed for the object to be detected according to an after image length for an after image in the object to be detected image.

In another embodiment, the moving speed for the object to be detected is computed according to the distance between the object to be detected and the speed detecting apparatus. However, such method for computing the moving speed is not limited to apply above-mentioned object to be detected images. Accordingly, such speed detecting method can be summarizes as: computing an object to be detected distance between the speed detecting apparatus and an objected to be detected via the distance computing apparatus; and computing a moving speed of the object to be detected according to the object to be detected distance.

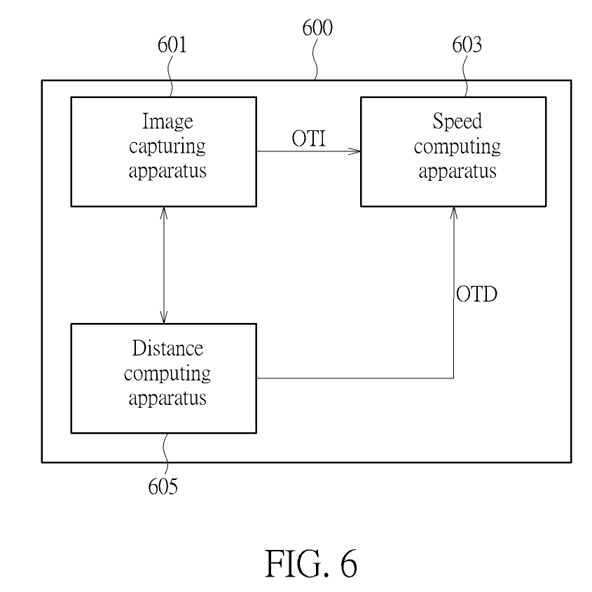

FIG. 6 is a schematic diagram illustrating a speed detecting apparatus 600 according to one embodiment of the present invention. As illustrated in FIG. 6, the speed detecting apparatus 600 comprises an image capturing apparatus 601 and a speed computing apparatus 603. The image capturing apparatus 601 captures at least one object to be detected image OTI. The speed computing apparatus 603 computes a moving speed for the object to be detected according to an after image length for an after image in the object to be detected image OTI. As above-mentioned description, the speed detecting 600 can further comprise a distance computing apparatus 605, which is configured to compute an object to be detected distance OTD between the object to be detected and the speed detecting apparatus 600. The speed detecting apparatus 600 can be integrated to any electronic apparatus and can share devices with the electronic apparatus. For example, if the speed detecting apparatus 600 is integrated to a mobile phone, the image capturing apparatus 601 is the camera in the mobile phone. Besides, the speed computing apparatus 603 and the distance computing apparatus 605 can be integrated to a processor of the mobile phone.

Additionally, as above-mentioned, in one embodiment a speed detecting method not using an image can be firstly applied, and then the distance computing apparatus 605 can be applied to compute the object to be detected distance. By this way, the accuracy for detecting the speed can be increased. In such embodiment, the image capturing apparatus 601 can be removed from the speed detecting apparatus 600.

In view of above-mentioned embodiments, an image can be applied to detect the moving speed of an object to be detected, thus the disadvantages in prior art can be improved. Also, the distance between the object to be detected and the image capturing apparatus can be further computed as a basement for detecting a moving speed. By this way, the accuracy for detecting a moving speed can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A speed detecting method, applied to a speed detecting apparatus comprising an image capturing apparatus, comprising:
(a) capturing at least one object to be detected image for an object to be detected via the image capturing apparatus; and
(b) computing a moving speed for the object to be detected according to an after image length for an after image in the object to be detected image.

2. The speed detecting method of claim 1, wherein the step (b) computes the moving speed of the object to be detected according to after image lengths for a plurality of object to be detected images.

3. The speed detecting method of claim 1, wherein the step (a) captures the image to be detected according to an image capturing time interval, wherein the step (b) further computes the moving speed according to the image capturing time interval.

4. The speed detecting method of claim 1, wherein the speed detecting apparatus further comprises a distance computing apparatus, wherein the speed detecting method further comprises:
(c) computing an object to be detected distance between the speed detecting apparatus and the object to be detected via the distance computing apparatus;
wherein the step (b) further computes the moving speed according to the object to be detected distance.

5. The speed detecting method of claim 4, wherein the speed detecting apparatus further comprises a light emitting device, wherein the step (c) controls the light emitting device to illuminate the object to be detected before computes the object to be detected distance.

6. The speed detecting method of claim 4, further comprising:
setting a distance range for an object to be detected distance between the object to be detected and the speed detecting apparatus according to a distance setting signal;
wherein the step (c) further computes the object to be detected distance according to the distance range.

7. The speed detecting method of claim 1, further comprising:
setting an object to be detected distance between the object to be detected and the speed detecting apparatus according to a distance setting signal;
wherein the step (b) further computes the moving speed according to the object to be detected distance.

8. A speed detecting method, applied to a speed detecting apparatus comprising a distance computing apparatus and a speed computing apparatus, the speed detecting method comprising:
(a) computing an object to be detected distance between the speed detecting apparatus and an objected to be detected via the distance computing apparatus; and
(b) computing a moving speed of the object to be detected according to the object to be detected distance via the speed computing apparatus.

9. A speed detecting apparatus, comprising:
an image capturing apparatus, configured to capture at least one object to be detected image for an object to be detected; and
a speed computing apparatus, configured to compute a moving speed for the object to be detected according to an after image length for an after image in the object to be detected image.

10. The speed detecting apparatus of claim 9, wherein the speed computing apparatus computes the moving speed of the object to be detected according to after image lengths for a plurality of object to be detected images.

11. The speed detecting apparatus of claim 10, wherein the image capturing apparatus captures the image to be detected according to an image capturing time interval, wherein the speed computing apparatus further computes the moving speed according to the image capturing time interval.

12. The speed detecting apparatus of claim 9, further comprising a distance computing apparatus configured to compute an object to be detected distance between the speed detecting apparatus and the object to be detected, wherein the speed computing apparatus further computes the moving speed according to the object to be detected distance.

13. The speed detecting apparatus of claim 12, further comprising a light emitting device, wherein the distance computing apparatus controls the light emitting device to illuminate the object to be detected before computes the object to be detected distance.

14. The speed detecting apparatus of claim 12, further setting a distance range for an object to be detected distance between the object to be detected and the speed detecting apparatus according to a distance setting signal, wherein the distance computing apparatus further computes the object to be detected distance according to the distance range.

15. The speed detecting apparatus of claim 9, further setting an object to be detected distance between the object to be detected and the speed detecting apparatus according to a distance setting signal, wherein the speed computing apparatus further computes the moving speed according to the object to be detected distance.

16. A speed detecting apparatus, comprising:
a distance computing apparatus, configured to compute an object to be detected distance between the speed detecting apparatus and an objected to be detected; and
a speed computing apparatus, configured to compute a moving speed of the object to be detected according to the object to be detected distance.
